(19) United States
(12) Patent Application Publication
(10) Pub. No.: US 2009/0181239 A1
(43) Pub. Date: Jul. 16, 2009

(54) CARBON NANOTUBE-BASED COMPOSITE MATERIAL AND METHOD FOR FABRICATING THE SAME

(75) Inventors: Shou-Shan Fan, Beijing (CN); Qun-Feng Cheng, Beijing (CN); Jia-Ping Wang, Beijing (CN); Kai-Li Jiang, Beijing (CN)

Correspondence Address: PCE INDUSTRY, INC.;ATT. Steven Reiss, 458 E. LAMBERT ROAD, FULLERTON, CA, 92835, US

(73) Assignees: Tsinghua University, Beijing (CN); HON HAI PRECISION INDUSTRY CO., LTD., Taipei Hsien (TW)

(21) Appl. No.: 12/246,340

(22) Filed: Oct. 6, 2008

(30) Foreign Application Priority Data
Jan. 11, 2008 (CN) 200810065181.0

(51) Int. Cl. B32B 5/16; B32B 9/00; B32B 3/00; B32B 37/06; B29C 43/00

(52) U.S. Cl. 428/327; 428/408; 427/372.2; 156/60; 264/241; 264/510; 977/742; 977/847; 977/842

(57) ABSTRACT

A carbon nanotube-based composite material includes a polymer matrix and a plurality of carbon nanotubes in the polymer matrix. The plurality of carbon nanotubes form a free standing carbon nanotube film structure. A method for fabricating the carbon nanotube-based composite material includes: providing a polymer matrix comprising a surface; providing at least one carbon nanotube film comprising a plurality of carbon nanotubes; disposing the at least one carbon nanotube film on the surface of the polymer matrix to obtain a preform; and heating the preform to combine the at least one carbon nanotube film with the polymer matrix.

### RELATED APPLICATIONS

This application is related to commonly-assigned applications entitled, “METHOD FOR MAKING CARBON NANOTUBE COMPOSITE”, (Atty. Docket No. US17642); and “METHOD FOR MAKING CARBON NANOTUBE COMPOSITE”, (Atty. Docket No. US18061). The disclosures of the above-identified applications are incorporated herein by reference and are filed simultaneously with the present application.

### BACKGROUND

1. Field of the Invention

The present invention relates to composite materials and methods for fabricating the same and, particularly, to a carbon nanotube-based composite material and a method for fabricating the same.

2. Discussion of Related Art

Carbon nanotubes (CNTs) are a carbonaceous material that has received a great deal of interest since the early 1990s, due to potentially useful heat and electrical conduction and mechanical properties. It is becoming increasingly popular for CNTs to be used as a filler in composite materials.

Presently, it is common for carbon nanotubes to be surface-modified before being embedded in polymers to form composite materials. A common method for fabricating a carbon nanotube-based composite material includes: providing multi-walled carbon nanotubes and concentrated nitric acid, and placing the carbon nanotubes into the concentrated nitric acid to form a mixture; agitating the mixture for 20 hours at 200° C.; washing the carbon nanotubes with distilled water, and drying the carbon nanotubes in a vacuum for 10 hours at 90° C.; placing the carbon nanotubes into oxalyl chloride to form a mixture, and agitating the mixture for 10 hours at 90° C.; vaporizing the excess oxalyl chloride, with the result being chlorinated carbon nanotubes; dripping diaminoethane into the chlorinated carbon nanotubes in an ice bath to form a first mixture, stirring the first mixture slowly, and drying the first mixture in vacuum for 10 hours at 100° C. to form aminated carbon nanotubes; placing the aminated carbon nanotubes into ethanol to form a second mixture and ultrasonically agitating the second mixture for 15 minutes; adding epoxide resin into the second mixture and rapidly stirring for 20 minutes; heating the second mixture to 60° C. to vaporize the ethanol, and adding a curing agent into the second mixture; and finally filling the second mixture into a die and heating at 80° C. for 2 hours, then heating at 150° C. for 2 hours, such that the second mixture is cured to form the carbon nanotube-based composite material.

The described method of agitating and stirring to disperse the carbon nanotubes in the polymer, however, presents disadvantages. The carbon nanotubes are prone to adhere to each other in the polymer, the surface modification results in defects on the structure of the carbon nanotubes which affect the overall properties of the carbon nanotubes, and the carbon nanotubes in the composite material are disorganized (i.e., not arranged in any particular axis). Furthermore, agents and organic solvents added during the manufacturing process are hard to eliminate, resulting in the achieved carbon nanotube-based composite material being impure. Hence, the fabricating method involving surface modification is complicated and has a relatively high cost.

What is needed, therefore, is a carbon nanotube-based composite material and a method for fabricating the same, in which the described limitations are eliminated or at least alleviated.

### SUMMARY

In an embodiment, a carbon nanotube-based composite material includes a polymer matrix and a plurality of carbon nanotubes in the polymer matrix. The plurality of carbon nanotubes form a free standing carbon nanotube film structure.

In another embodiment, a method for fabricating the carbon nanotube-based composite material includes: providing a polymer matrix comprising a surface; providing at least one carbon nanotube film comprising a plurality of carbon nanotubes; disposing the at least one carbon nanotube film on the surface of the polymer matrix to obtain a preform; and heating the preform to combine the at least one carbon nanotube film with the polymer matrix.

Other novel features and advantages of the present carbon nanotube-based composite material and method for fabricating the same will become more apparent from the following detailed description of exemplary embodiments when taken in conjunction with the accompanying drawings.

### BRIEF DESCRIPTION OF THE DRAWINGS

Many aspects of the present carbon nanotube-based composite material and method for fabricating the same can be better understood with reference to the following drawings. The components in the drawings are not necessarily drawn to scale, the emphasis instead being placed upon clearly illustrating the principles of the present carbon nanotube-based composite material and method for fabricating the same.

FIG. 1 is a cross-section of a carbon nanotube-based composite material in accordance with a present embodiment.

FIG. 2 is similar to FIG. 1, but showing more detail.

FIG. 3 is an exploded, isometric view of a carbon nanotube film structure of the carbon nanotube-based composite material of FIG. 2.

FIG. 4 is a flowchart of an exemplary method for fabricating the carbon nanotube-based composite material of FIG. 1.

FIG. 5 is a cross-section of a preform of the carbon nanotube-based composite material of FIG. 1.

FIG. 6 is a cross-section of an apparatus for fabricating the carbon nanotube-based composite material of FIG. 1.

Corresponding reference characters indicate corresponding parts throughout the several views. The exemplifications set out herein illustrate at least one embodiment of the present carbon nanotube-based composite material and method for fabricating the same, in at least one form, and such exemplifications are not to be construed as limiting the scope of the invention in any manner.

### DETAILED DESCRIPTION OF EXEMPLARY EMBODIMENTS

Reference will now be made to the drawings to describe, in detail, embodiments of the present carbon nanotube-based composite material and method for fabricating the same.

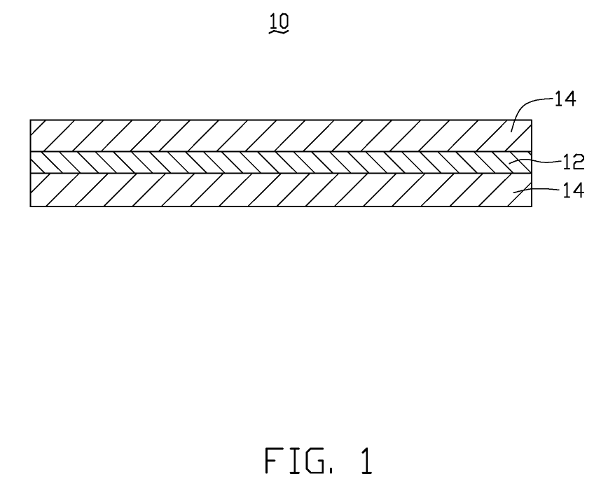

Referring to FIG. 1, a carbon nanotube-based composite material 10 includes a polymer matrix 14 and a plurality of carbon nanotubes dispersed therein. The carbon nanotubes form a carbon nanotube film structure 12 in the polymer matrix 14. The carbon nanotube film structure 12 is free standing. Free standing means the carbon nanotubes combine, connect or join with each other by van der Waals attractive force, to form a film structure. The film structure being supported by itself and does not need a substrate to lay on and supported thereby. When someone holding at least a point of the carbon nanotube film structure, the entire carbon nanotube film structure can be lift without destroyed.

The polymer matrix 14 includes upper and lower layer portions, and can be made of thermosetting resin or thermoplastic resin. The material of the thermosetting resin can be phenolic, epoxy, bismaleimide, polybenzoxazine, cyanate ester, polyimide, unsaturated polyamide ester, or any combination thereof. The material of the thermoplastic resin can be polyethylene, polyvinyl chloride, polytetrafluoroethylene, polypropylene, polystyrene, polymethyl methacrylate acrylic, polyethylene terephthalate, polycarbonate, polyamide, poly(butylene terephthalate), polyether ketone, polyether sulfone, ether sulfone, thermoplastic polyimide, polyetherimide, polyphenylene sulfide, polyvinyl acetate, paraphenylene benzobisoxazole, or any combination thereof.

The carbon nanotube film structure 12 includes one or a plurality of stacked carbon nanotube layers. Each carbon nanotube layer includes one carbon nanotube film, or a plurality of carbon nanotube films disposed side-by-side (coplanar). The carbon nanotubes in each carbon nanotube film are aligned parallel to the same axis. When there are a plurality of carbon nanotube films disposed side-by-side, typically, the carbon nanotubes in all the carbon nanotube films are aligned parallel to the same axis. More specifically, each carbon nanotube film includes a plurality of successive and oriented carbon nanotubes joined end-to-end by van der Waals attractive force. A length and a width of the carbon nanotube film can be arbitrarily set as desired. A thickness of the carbon nanotube film can be approximately 0.5 nanometers (nm) to 100 microns (μm). The carbon nanotubes in the carbon nanotube film can be single-walled, double-walled, or multi-walled. Diameters of the single-walled carbon nanotubes can be from 0.5 nm to 50 nm, diameters of the double-walled carbon nanotubes can be from 1 nm to 50 nm, and diameters of the multi-walled carbon nanotubes can be from 1.5 nm to 50 nm.

When the carbon nanotube film structure 12 includes two or more carbon nanotube layers stacked one on another, the adjacent carbon nanotube layers are combined by Van de Waals attractive force, thereby providing the carbon nanotube film structure 12 with stability. An angle α between the alignment axes of the carbon nanotubes in each two adjacent carbon nanotube layers is 0≦α≦90°.

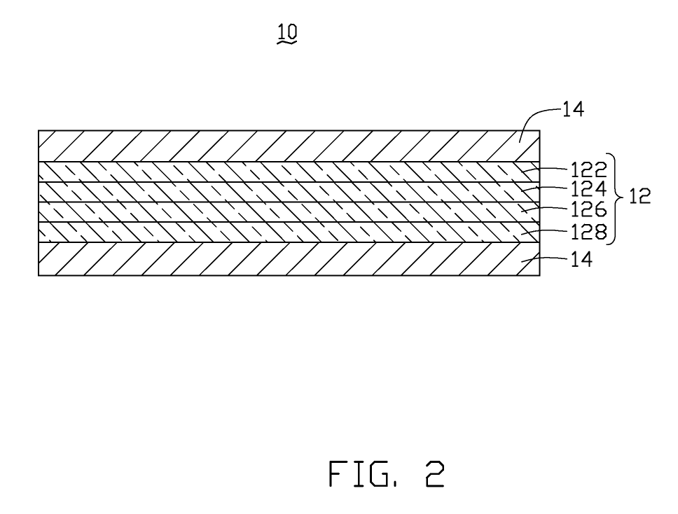

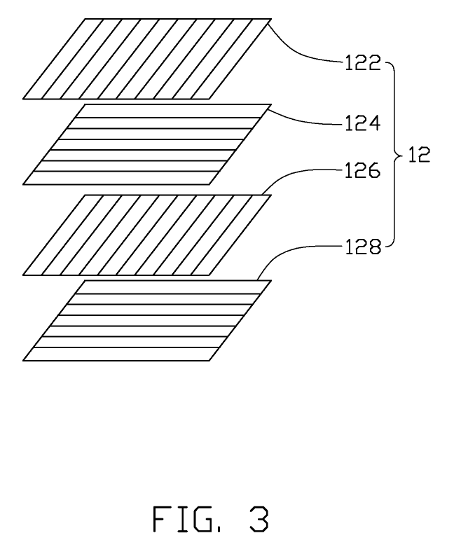

Referring to FIGS. 2 and 3, in the present embodiment, the carbon nanotube structure 12 includes a first carbon nanotube layer 122, a second carbon nanotube layer 124, a third carbon nanotube layer 126, and a fourth carbon nanotube layer 128. The thickness of the carbon nanotube film structure 12 is from about 0.04 μm to about 400 μm. α is approximately 90°.

In the carbon nanotube-based composite material 10, the carbon nanotube film structure 12 is positioned in a central layer region between the upper and lower layer portions of the polymer matrix 14, with the carbon nanotubes uniformly disposed in the carbon nanotube film structure 12. A plurality of interspaces are defined between the carbon nanotubes, and the polymer matrix 14 fills the interspaces. That is, the carbon nanotube film structure 12 is soaked by and combined with the polymer matrix 14 to form the carbon nanotube-based composite material 10.

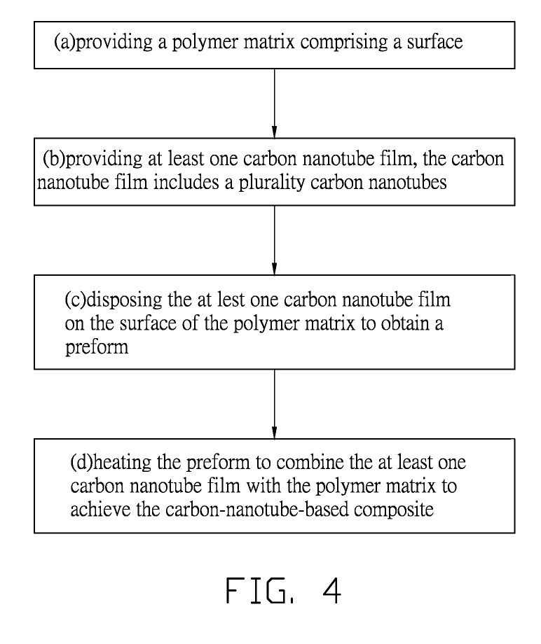

Referring to FIG. 4, an exemplary method for fabricating the carbon nanotube-based composite material 10 includes: (a) providing a discrete layer of the polymer matrix 14; (b) providing at least one carbon nanotube film, each including a plurality of carbon nanotubes; (c) disposing the at least one carbon nanotube film on a surface of the layer of polymer matrix 14 to create a preform; and (d) heating the preform to combine the carbon nanotube film(s) with the layer of polymer matrix 14 and produce the carbon nanotube-based composite material 10.

In step (a), the layer of polymer matrix 14 can be formed by: (a1) providing a liquid allylphenol, and filling the liquid allylphenol into a container; (a2) heating and stirring the liquid allylphenol in the container at about 90° C.˜180° C. for several minutes; (a3) adding bismaleimide powder into the liquid allylphenol at about 110˜160° C. to form a mixture, and letting the mixture rest for several minutes at the same temperature; (a4) evacuating air from the container for several minutes to create a vacuum and remove gas within the liquid, thereby achieving a pure liquid; and (a5) filling the liquid into a mold and cooling to room temperature to achieve the layer of polymer matrix 14.

In step (a3), a weight ratio of the bismaleimide powder to the liquid allylphenol is in the approximate range from 60:5 to 60:70. In step (a5), the thickness and shape of the layer of polymer matrix 14 are defined by the mold.

It will be apparent to those skilled in the art that the layer of polymer matrix 14 can also be achieved by other methods known in the art, such as, for example, spraying, coating, or flowing.

In step (b), the carbon nanotube film can be formed by: (b1) providing an array of carbon nanotubes, specifically, a super-aligned array of carbon nanotubes; and (b2) pulling out a carbon nanotube film from the array of carbon nanotubes via a pulling tool (e.g., adhesive tape, pliers, tweezers, or another tool allowing multiple carbon nanotubes to be gripped and pulled simultaneously).

In step (b1), the super-aligned array of carbon nanotubes can be formed by: (b11) providing a substantially flat and smooth substrate; (b12) forming a catalyst layer on the substrate; (b13) annealing the substrate with the catalyst layer in air at a temperature from about 700° C.˜900° C. for about 30 to 90 minutes; (b14) heating the substrate with the catalyst layer to a temperature from about 500° C.˜740° C. in a furnace with a protective gas therein; and (b15) supplying a carbon source gas to the furnace for about 5 to 30 minutes and growing the super-aligned array of carbon nanotubes on the substrate.

In step (b11), the substrate can be a P-type silicon wafer, an N-type silicon wafer, or a silicon wafer with a film of silicon dioxide thereon. Preferably, a 4-inch P-type silicon wafer is used as the substrate.

In step (b12), the catalyst can be made of iron (Fe), cobalt (Co), nickel (Ni), or any alloy thereof.

In step (b14), the protective gas can be made up of at least one of the following: nitrogen (N₂), ammonia (NH₃), and a noble gas. In step (b15), the carbon source gas can be a hydrocarbon gas, such as ethylene (C₂H₄), methane (CH₄), acetylene (C₂H₂), ethane (C₂H₆), or any combination thereof.

The super-aligned array of carbon nanotubes can be about 200 to 400 μm in height, and include a plurality of carbon nanotubes parallel to each other and approximately perpendicular to the substrate. The carbon nanotubes in the array can be single-walled carbon nanotubes, double-walled carbon nanotubes, or multi-walled carbon nanotubes. Diameters of the single-walled carbon nanotubes are approximately 0.5 nm to 10 nm, diameters of the double-walled carbon nanotubes are approximately 1 nm to 50 nm, and diameters of the multi-walled carbon nanotubes are approximately 1.5 nm to 50 nm.

The super-aligned array of carbon nanotubes formed under the above conditions is essentially free of impurities such as carbonaceous or residual catalyst particles. The carbon nanotubes in the super-aligned array are closely packed together by van der Waals attractive force.

In step (b2), the carbon nanotube film can be formed by: (b21) selecting one or more carbon nanotubes having a predetermined width from the super-aligned array of carbon nanotubes; and (b22) pulling the carbon nanotubes at an even/uniform speed to form nanotube segments and achieve a uniform carbon nanotube film.

In step (b21), the carbon nanotubes having a predetermined width can be selected by using an adhesive tape as the tool to contact the super-aligned array of carbon nanotubes. Each carbon nanotube segment includes a plurality of carbon nanotubes parallel to each other. In step (b22), the pulling direction is substantially perpendicular to the growing direction of the super-aligned array of carbon nanotubes.

Specifically, during the pulling process, as the initial carbon nanotube segment is drawn out, other carbon nanotube segments are also drawn out end-to-end due to the van der Waals attractive force between ends of adjacent segments. This process of drawing ensures that a continuous, uniform carbon nanotube film having a certain width can be formed. The carbon nanotube film includes a plurality of carbon nanotubes joined end-to-end. The carbon nanotubes in the carbon nanotube film are all substantially parallel to the pulling/drawing direction, and the carbon nanotube film produced in such manner can be selectively formed to have a predetermined width. The carbon nanotube film formed by the pulling/drawing method has superior uniformity of thickness and conductivity over a typical carbon nanotube film in which the carbon nanotubes are disorganized and not arranged along any particular axis. Furthermore, the pulling/drawing method is simple and fast, thereby making it suitable for industrial applications.

The maximum width possible for the carbon nanotube film depends on the size of the carbon nanotube array. The length of the carbon nanotube film can be arbitrarily set, as desired. When the substrate is a 4-inch P-type silicon wafer, as in the present embodiment, the width of the carbon nanotube film can be from about 0.01 centimeters (cm) to about 10 cm, and the thickness of the carbon nanotube film is from about 0.5 nm to about 100 μm.

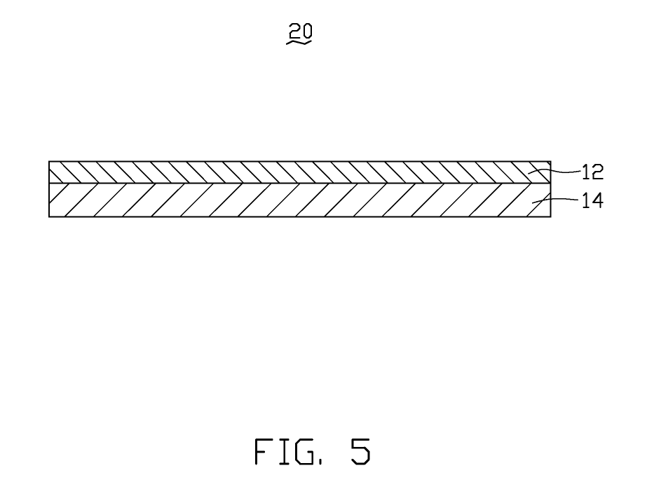

Referring to FIG. 5, in step (c), it is noted that because the carbon nanotubes in the super-aligned carbon nanotube array have a high purity and a high specific surface area, the carbon nanotube film is adherent in nature. As a result, at least one carbon nanotube film can be directly adhered to the surface of the layer of polymer matrix 14 and thus form the carbon nanotube film structure 12 on the layer of polymer matrix 14, thereby creating a preform 20. For example, a plurality of carbon nanotube films can be contactingly adhered on the surface of the layer of polymer matrix 14 side-by-side and coplanar with each other, to thereby form a carbon nanotube film structure 12 having a single carbon nanotube layer. In another example, two or more such carbon nanotube layers can be stacked one on the other on the surface of the layer of polymer matrix 14 to form a carbon nanotube film structure 12 with stacked carbon nanotube layers. The angle α between the alignment axes of the carbon nanotubes in each two adjacent carbon nanotube layers is 0≦α≦90°. In the present embodiment, the angle α is about 90°. In each carbon nanotube layer, a space is defined between every two adjacent carbon nanotubes. The carbon nanotubes in each two adjacent carbon nanotube layers cross each other, thereby providing the carbon nanotube film structure 12 with a microporous structure. A diameter of each micropore in the microporous structure is from about 1 nm to about 0.5 μm.

In another embodiment, after disposing the carbon nanotube film structure 12 on the layer of polymer matrix 14, another discrete layer of polymer matrix 14 can be further provided and covered on the carbon nanotube film structure 12.

It is to be understood that when the size of the as-formed carbon nanotube film exceeds that of the surface of the layer of polymer matrix 14, the excess carbon nanotube film can be removed. The carbon nanotube film can be sized and shaped as needed by laser cutting in air. The cutting can be performed before or after the adhering step. In the following description, unless the context indicates otherwise, it will be assumed that the carbon nanotube film is adhered on the surface of the layer of polymer matrix 14 prior to a cutting step.

It will be apparent to those having ordinary skill in the art that the carbon nanotube film structure 12 can first be formed in a tool (e.g. a frame). The formed carbon nanotube film structure 12 can then be adhered on the surface of the layer of polymer matrix 14 to achieve the preform 20. In another embodiment of the preform 20, the carbon nanotube film structure 12 can be adheringly sandwiched between two layers of polymer matrix 14 (i.e., another layer of polymer matrix 14 can be disposed on the surface of the carbon nanotube film structure 12 to form the preform 20).

Each carbon nanotube film can be treated with an organic solvent. Specifically, the organic solvent can be dropped from a dropper onto the carbon nanotube film to soak the entire surface thereof. The organic solvent is volatilizable and can be ethanol, methanol, acetone, dichloroethane, chloroform, or any appropriate mixture thereof. In the present embodiment, the organic solvent is ethanol. After being soaked in the organic solvent, the carbon nanotube segments in the nanotube film can, at least partially, shrink into carbon nanotube bundles and firmly adhere to the surface of the layer of polymer matrix 14 due, in part at least, to the surface tension created by the organic solvent. Due to the decrease of the specific surface area via bundling, the coefficient of friction of the carbon nanotube film is reduced, while the high mechanical strength and toughness is maintained. It is to be understood that in alternative embodiments, each carbon nanotube film or each carbon nanotube layer or the carbon nanotube film structure 12 can be treated with an organic solvent before being adhered on the layer of polymer matrix 14. In these situations, each carbon nanotube film or each carbon nanotube layer or the carbon nanotube film structure 12 can be adhered on a frame and soaked in an organic solvent bath. Then, the treated carbon nanotube film or carbon nanotube layer or carbon nanotube film structure 12 can be disposed on the layer of polymer matrix 14.

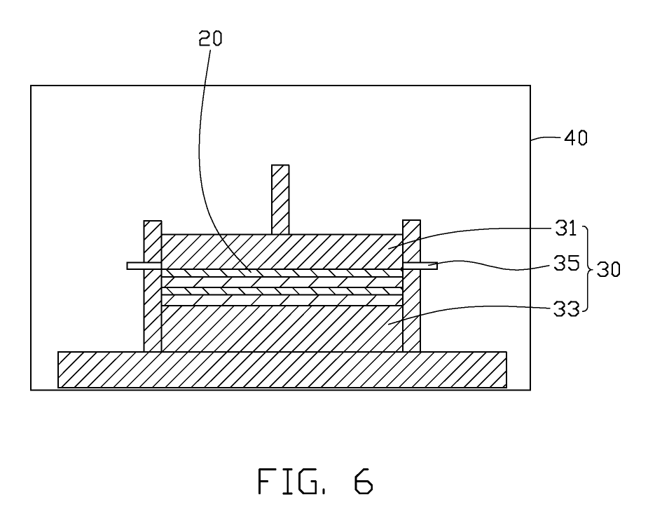

Referring to FIG. 6, step (d) typically includes: (d1) providing a mold 30 including an upper board 31 and a lower board 33, and disposing the preform 20 therebetween; (d2) heating the mold 30 to melt the layer of polymer matrix 14, thereby filling the interspaces between the carbon nanotubes of the carbon nanotube structure 12 with the polymer matrix 14; and (d3) solidifying the polymer matrix 14 and removing it from the mold 30 to achieve the carbon nanotube-based composite material 10.

In step (d1), the mold 30 includes the upper board 31, the lower board 33, a sidewall, and a through hole 35 therein. A releasing agent is applied inside the mold 30 for demolding the carbon nanotube-based composite material 10 formed therein. It is noted that in alternative embodiments, a plurality of preforms 20 can be stacked and disposed between the upper board 31 and the lower board 33 of the mold 30 simultaneously. In FIG. 5, two stacked preforms 20 in the mold 30 are shown.

Step (d2) can include: (d21) disposing the mold 30 in a heating device 40 (e.g. a hot-pressing machine); (d22) applying a pressure less than 100 mega-pascals (Mpa) on the preform 20 through the upper board 31 and the lower board 33 at an elevated temperature (e.g. about 100° C.˜150° C.); (d23) evacuating the air in the heating device 40 until the pressure of the air therein is below −0.01 MPa, and maintaining the pressure on the preform 20 and the temperature for a period of time (e.g., about 1 to 5 hours); and (d24) relieving the pressure on the preform 20.

The layer of polymer matrix 14 is in a liquid state at 100° C.˜150° C. Through hot pressing, the layer of polymer matrix 14 infiltrates the interspaces between the carbon nanotubes and forms a composite material. Excess polymer matrix 14 can be drained through the through hole 35. The air in the interspaces between the carbon nanotubes can be removed in step (d23) by a vacuum pump (not shown) connected to the heating device 40.

In step (d3), the preform 20 is cooled to room temperature, thereby solidifying the polymer matrix 14 to achieve the carbon nanotube-based composite material 10.

When the polymer matrix 14 is thermosetting resin, an additional heating of the preform 20 is further provided before the cooling in step (d3). To avoid explosive polymerization of the polymer matrix 14, the temperature must be slowly elevated. The heating step includes three temperature periods: 150° C.˜180° C. for 2˜4 hours, 180° C.˜200° C. for 1˜5 hours, and 200° C.˜230° C. for 2˜20 hours.

When the polymer matrix 14 is thermoplastic resin, the above-described additional heating of the preform 20 is not required.

In the present embodiment, the carbon nanotube-based composite material 10 is formed by combining the carbon nanotube film structure 12 with the layer of polymer matrix 14. As such, the carbon nanotubes can be uniformly dispersed in the carbon nanotube film structure 12 in the central layer region between the upper and lower layer portions of the polymer matrix 14 without the need for surface treatment of the carbon nanotubes. The carbon nanotube film structure 12 is substantially free of defects, and the carbon nanotube-based composite material 10 is a single, integrated body of material. Moreover, the alignment of the carbon nanotubes in the carbon nanotube-based composite material 10 is ordered. Thus, the electrical and thermal conductivity of the carbon nanotube-based composite material 10 can be improved. Additionally, the method for fabricating the carbon nanotube-based composite material 10 is simple and cost effective.

It is to be understood that the above-described embodiments are intended to illustrate rather than limit the invention. Variations may be made to the embodiments without departing from the spirit of the invention as claimed. The above-described embodiments illustrate the scope of the invention but do not restrict the scope of the invention.

It is also to be understood that the above description and the claims drawn to a method may include some indication in reference to sequential performance of actions. However, any such indication used is only for exemplary purposes and is not to be construed as suggesting a single particular fixed order in which the actions must be performed.

What is claimed is:

1. A carbon nanotube-based composite material comprising:
a polymer matrix; and
a plurality of carbon nanotubes in the polymer matrix, the plurality of carbon nanotubes form a free standing carbon nanotube film structure.

2. The carbon nanotube-based composite material of claim 1, wherein the polymer matrix is thermosetting resin selected from the group consisting of phenolic, epoxy, bismaleimide, polybenzoxazine, cyanate ester, polyimide, unsaturated polyamide ester, and any combination thereof.

3. The carbon nanotube-based composite material of claim 1, wherein the polymer matrix is thermoplastic resin selected from the group consisting of polyethylene, polyvinyl chloride, polytetrafluoroethylene, polypropylene, polystyrene, polymethyl methacrylate acrylic, polyethylene terephthalate, polycarbonate, polyamide, poly(butylene terephthalate), polyether ketone, polyether sulfone, ether sulfone, thermoplastic polyimide, polyetherimide, polyphenylene sulfide, polyvinyl acetate, paraphenylene benzobisoxazole, and any combination thereof.

4. The carbon nanotube-based composite material of claim 1, wherein the carbon nanotube film structure defines a plurality of interspaces between the carbon nanotubes therein, and the polymer matrix fills the interspaces.

5. The carbon nanotube-based composite material of claim 1, wherein the carbon nanotube film structure comprises at least one carbon nanotube layer, and when the carbon nanotube film structure comprises a plurality of carbon nanotube layers, the carbon nanotube layers are stacked one on the other.

6. The carbon nanotube-based composite material of claim 5, wherein at least one of the carbon nanotube layer comprises at least one carbon nanotube film, the carbon nanotubes in at least one carbon nanotube film are aligned parallel to a same axis, and when said at least one of the carbon nanotube layer comprises a plurality of carbon nanotube films, the carbon nanotube films are disposed side-by-side.

7. The carbon nanotube-based composite material of claim 6, wherein an angle between the alignment axes of the carbon nanotubes in two adjacent stacked carbon nanotube layers is from 0° to 90°.

8. The carbon nanotube-based composite material of claim 6, wherein a thickness of each carbon nanotube film is from about 0.5 nm to about 100 μm.

9. The carbon nanotube-based composite material of claim 6, wherein each of the at least one carbon nanotube film comprises a plurality of successive carbon nanotubes joined end-to-end by van der Waals attractive force therebetween.

10. A method for fabricating a carbon nanotube-based composite material, the method comprising:
(a) providing a polymer matrix comprising a surface;
(b) providing at least one carbon nanotube film comprising a plurality of carbon nanotubes;
(c) disposing the at least one carbon nanotube film on the surface of the polymer matrix to obtain a preform; and
(d) heating the preform to combine the at least one carbon nanotube film with the polymer matrix.

11. The method of claim 10, wherein (b) comprises:
(b1) providing an array of carbon nanotubes; and
(b2) pulling the at least one carbon nanotube film out from the array of carbon nanotubes via a pulling tool.

12. The method of claim 10, wherein in (c), the at least one carbon nanotube film is adhered to the surface of the polymer matrix to form a carbon nanotube film structure thereon, and an excess portion of the carbon nanotube film structure is removed by cutting.

13. The method of claim 10, wherein the at least one carbon nanotube film is a plurality of carbon nanotube films, the carbon nanotube films are adhered on the surface of the polymer matrix side-by-side to form at least one carbon nanotube layer, the carbon nanotube film structure comprises the at least one carbon nanotube layer, and when the at least one carbon nanotube layer is a plurality of carbon nanotube layers, the carbon nanotube layers are stacked one on the other on the surface of the polymer matrix.

14. The method of claim 10, wherein in (b) and (c), the at least one carbon nanotube film is a plurality of carbon nanotube films, and the carbon nanotube films are formed into a carbon nanotube film structure before being adhered on the surface of the polymer matrix.

15. The method of claim 10, wherein the at least one carbon nanotube film is treated with an organic solvent, and the organic solvent is volatilizable and selected from the group consisting of ethanol, methanol, acetone, dichloroethane, chloroform, and any mixture thereof.

16. The method of claim 10, wherein (d) comprises:
(d1) providing a mold comprising an upper board and a lower board, and disposing the preform between the upper board and the lower board of the mold;
(d2) heating the mold to melt the polymer matrix such that the polymer matrix fills interspaces between the carbon nanotubes; and
(d3) solidifying the polymer matrix, and removing the mold to achieve the carbon nanotube-based composite material.

17. The method of claim 16, wherein (d2) comprises:
(d21) disposing the mold in a heating device;
(d22) applying a pressure below 100 mega-pascals (Mpa) on the preform through the upper board and the lower board at about 100° C.˜150° C.;
(d23) evacuating air in the heating device until the air pressure therein is below −0.01 MPa, and maintaining the pressure on the preform and the temperature for about 1 to 5 hours; and
(d24) relieving the pressure on the preform.

18. The method of claim 16, wherein the polymer matrix is thermosetting resin, and in (d3) the preform is gradually heated to an elevated temperature, and then cooled to room temperature to cure the polymer matrix.

19. The method of claim 16, wherein the polymer matrix is thermoplastic resin, and in (d3) the preform is cooled to room temperature to solidify the polymer matrix.

20. The method of claim 10, wherein step (c) further comprising a step of providing another polymer matrix, and disposing the polymer matrix on the carbon nanotube film to obtain the preform.
